(19) United States
(12) Patent Application Publication
(10) Pub. No.: US 2016/0027168 A1
(43) Pub. Date: Jan. 28, 2016

(54) IMAGE DISPLAY APPARATUS, IMAGE OUTPUT APPARATUS, CONTROL METHOD FOR IMAGE DISPLAY APPARATUS, AND CONTROL METHOD FOR IMAGE OUTPUT APPARATUS

(71) Applicant: CANON KABUSHIKI KAISHA, Tokyo (JP)

(72) Inventors: Takeshi Ikeda, Ebina-shi (JP); Miyako Takahashi, Kawasaki-shi (JP)

(21) Appl. No.: 14/799,890

(22) Filed: Jul. 15, 2015

(30) Foreign Application Priority Data
Jul. 22, 2014 (JP) 2014-148801

(51) Int. Cl. G06T 7/00; H04N 5/235; H04N 1/407; G09G 3/36; H04N 5/202

(52) U.S. Cl. CPC G06T 7/0012; G09G 3/36; G09G 3/3607; H04N 5/202; H04N 1/4078; H04N 5/2351; G09G 2320/0233; G09G 2320/0276; G09G 2320/0646; G09G 2320/066; G09G 2320/0666; G09G 2320/0673; G09G 2340/0428; G06T 2207/10116; G06T 2207/10024; G06T 2207/30068

(57) ABSTRACT

An image display apparatus includes: an emission unit that has a plurality of light sources; a display unit configured to display an image on a screen by modulating light from the emission unit; a first acquisition unit configured to acquire input image data; a second acquisition unit configured to acquire processing information, which is information on image processing executed when the input image data is generated; a detection unit configured to detect a predetermined area in an area of an image represented by the input image data, based on gradation values of the input image data and the processing information; and a control unit configured to control emission brightness of each light source based on the detection result of the detection unit.

### BACKGROUND OF THE INVENTION

1. Field of the Invention

The present invention relates to an image display apparatus, an image output apparatus, a control method for an image display apparatus, and a control method for an image output apparatus.

2. Description of the Related Art

As a prior art on a liquid crystal display apparatus, a technique to individually control emission brightness of a plurality of light sources of a backlight based on image data, has been proposed. For example, emission brightness of a plurality of light sources is individually controlled based on image data, and transmittance of each liquid crystal element is corrected, whereby a change in display brightness (brightness on the screen) caused by a change in emission brightness of each light source is controlled (Japanese Patent Application Laid-Open No. 2002-99250). If such a technique is used, black floating in a dark portion of a display image (an image displayed on a screen) can be reduced and contrast of the display image can be enhanced. The light source control for individually controlling emission brightness of a plurality of light sources is called “local dimming control”.

A prior art on a medical display apparatus that has been proposed is a technique to detect a background area in an area of a medical image, and control emission brightness of each light source based on the background area detection result (Japanese Patent Application Laid-Open No. 2013-148870). The medical image is an X-rayed diagnostic image. In the technique disclosed in Japanese Patent Application Laid-Open No. 2013-148870, the emission brightness of light sources disposed in an area outside the background area (object (diagnosis target) area) is controlled to a first level. And emission brightness of light sources disposed in the background area is controlled to a level that is lower than the first level (second or third level).

By using the technique disclosed in Japanese Patent Application Laid-Open No. 2013-148870, the contrast of the display image can be enhanced, and changes of display brightness and display colors (colors on the screen) in the object area due to local dimming control can be suppressed. In concrete terms, the display brightness and display colors (colors on the screen) of the object can be maintained by controlling the emission brightness of the plurality of light sources disposed in the object area to a same level. Then by reducing the emission brightness of the light sources disposed in the background area, a display image with less black floating in the background area (display image in which contrast of the background is enhanced) can be acquired.

When a medical image is displayed and read on the screen, the operator may adjust the gradation values of the medical image data (image data representing a medical image) generated by modality in X-ray equipment and mammography equipment. For example, using a viewer application for image reading installed on a workstation or the like, offset processing to add an offset value to gradation values of the medical image data or gamma conversion processing to convert gradation values of the medical data by using a gamma value, for example, is executed.

However if this kind of adjustment is executed, the background area may be detected with errors in the image display apparatus, and emission brightness of each light source may not be accurately controlled.

In concrete terms, the background area is detected based on the gradation values of the image data inputted to the image display apparatus. But if the above mentioned adjustment is executed, not only the gradation values of the object area but also the gradation values of the background area change. Then the image data after the adjustment is inputted to the image display apparatus. Therefore if the above mentioned adjustment is executed, detection errors caused by the change in the gradation values of the background (detection errors of background area) may be generated.

### SUMMARY OF THE INVENTION

The present invention provides a technique that allows to accurately control the emission brightness of each light source even if the gradation values of the image data are changed.

The present invention in its first aspect provides an image display apparatus that can be connected with an image output apparatus, comprising:

an emission unit that has a plurality of light sources;

a display unit configured to display an image on a screen by modulating light from the emission unit;

a first acquisition unit configured to acquire input image data from the image output apparatus;

a second acquisition unit configured to acquire processing information, which is information on image processing executed when the input image data is generated, from the image output apparatus;

a detection unit configured to detect a predetermined area in an area of an image represented by the input image data, based on gradation values of the input image data and the processing information; and

a control unit configured to control emission brightness of each light source based on the detection result of the detection unit, when an image based on the input image data is displayed on the screen.

The present invention in its second aspect provides an image output apparatus that can be connected with an image display apparatus, comprising:

an image processing unit configured to generate input image data from original image data by executing image processing;

a first output unit configured to output the input image data to the image display apparatus; and

a second output unit configured to output processing information, which is information on the image processing, to the image display apparatus.

The present invention in its third aspect provides an image output apparatus that can be connected with an image display apparatus, wherein

the image display apparatus includes:

an emission unit that has a plurality of light sources; and

a display unit configured to display an image on a screen by modulating light from the emission unit, and

the image output apparatus includes:

an image processing unit configured to generate input image data from original image data by executing at least one image processing;

a detection unit configured to detect a predetermined area in an area of an image represented by the input image data, based on gradation values of processed image data, which is generated from the original image data by executing a part or all of the at least one image processing, and processing information that is information on image processing executed when the processed image data is generated;

a first output unit configured to output the input image data to the image display apparatus; and

a fourth output unit configured to output control reference information, which is information on the detection result of the detection unit and is information used for controlling emission brightness of each light source, to the image display apparatus.

The present invention in its fourth aspect provides a control method for an image display apparatus that can be connected with an image output apparatus,

the image display apparatus including:

an emission unit that has a plurality of light sources; and

a display unit configured to display an image on a screen by modulating light from the emission unit,

the control method for the image display apparatus comprising:

a first acquisition step of acquiring input image data from the image output apparatus;

a second acquisition step of acquiring processing information, which is information on image processing executed when the input image data is generated, from the image output apparatus;

a detection step of detecting a predetermined area in an area of an image represented by the input image data, based on gradation values of the input image data and the processing information; and

a control step of controlling emission brightness of each light source based on the detection result in the detection step, when an image based on the input image data is displayed on the screen.

The present invention in its fifth aspect provides a control method for an image output apparatus that can be connected with an image display apparatus, comprising:

an image processing step of generating input image data from original image data by executing image processing;

a first output step of outputting the input image data to the image display apparatus; and

a second output step of outputting processing information, which is information on the image processing, to the image display apparatus.

The present invention in its sixth aspect provides a control method for an image output apparatus that can be connected with an image display apparatus,

the image display apparatus including:

an emission unit that has a plurality of light sources; and

a display unit configured to display an image on a screen by modulating light from the emission unit,

the control method for the image output apparatus comprising:

an image processing step of generating input image data from original image data by executing at least one image processing;

a detection step of detecting a predetermined area in an area of an image represented by the input image data based on gradation values of processed image data, which is generated from the original image data by executing a part or all of the at least one image processing, and processing information that is information on image processing executed when the processed image data is generated;

a first output step of outputting the input image data to the image display apparatus; and

a fourth output step of outputting control reference information, which is information on the detection result in the detection step and is information used for controlling emission brightness of each light source, to the image display apparatus.

The present invention in its seventh aspect provides a non-transitory computer readable medium that stores a program, wherein the program causes a computer to execute the control method for the image display apparatus.

The present invention in its eighth aspect provides a non-transitory computer readable medium that stores a program, wherein the program causes a computer to execute the control method for the image output apparatus.

According to the present invention, the emission brightness of each light source can be properly controlled even if the gradation values of the image data are changed.

Further features of the present invention will become apparent from the following description of exemplary embodiments with reference to the attached drawings.

### BRIEF DESCRIPTION OF THE DRAWINGS

FIG. 1 is a block diagram depicting an example of a functional configuration of an image display system according to Example 1;

FIG. 2A and FIG. 2B show an example of an input image and characteristic values according to Example 1;

FIG. 3 is a block diagram depicting an example of a functional configuration of a viewer according to Example 1;

FIG. 4A to FIG. 4C show an example of an input image according to Example 1;

FIG. 5A to FIG. 5C show an example of characteristic values, area determination result and emission brightness according to Example 1;

FIG. 6A and FIG. 6B show an example of an emission state of each light source and a display image according to Example 1;

FIG. 7 is a block diagram depicting an example of a functional configuration of an image display system according to Example 2;

FIG. 8 is a block diagram depicting an example of a functional configuration of a viewer according to Example 2; and

FIG. 9A and FIG. 9B show an example of an area determination result and target brightness according to Example 2.

### DESCRIPTION OF THE EMBODIMENTS

### Example 1

An image display apparatus, an image output apparatus and control methods thereof according to Example 1 of the present invention will now be described.

In this example, a case when the image display apparatus is a transmission type liquid crystal display apparatus will be described, but the image display apparatus is not limited to the transmission type liquid crystal display apparatus. The image display apparatus can be any image display apparatus that displays an image on a screen by modulating light from an emission unit. For example, the image display apparatus may be a reflection type liquid crystal display apparatus. The image display apparatus may be an MEMS (Micro Electro Mechanical System) shutter type display that uses MEMS shutters instead of liquid crystal elements.

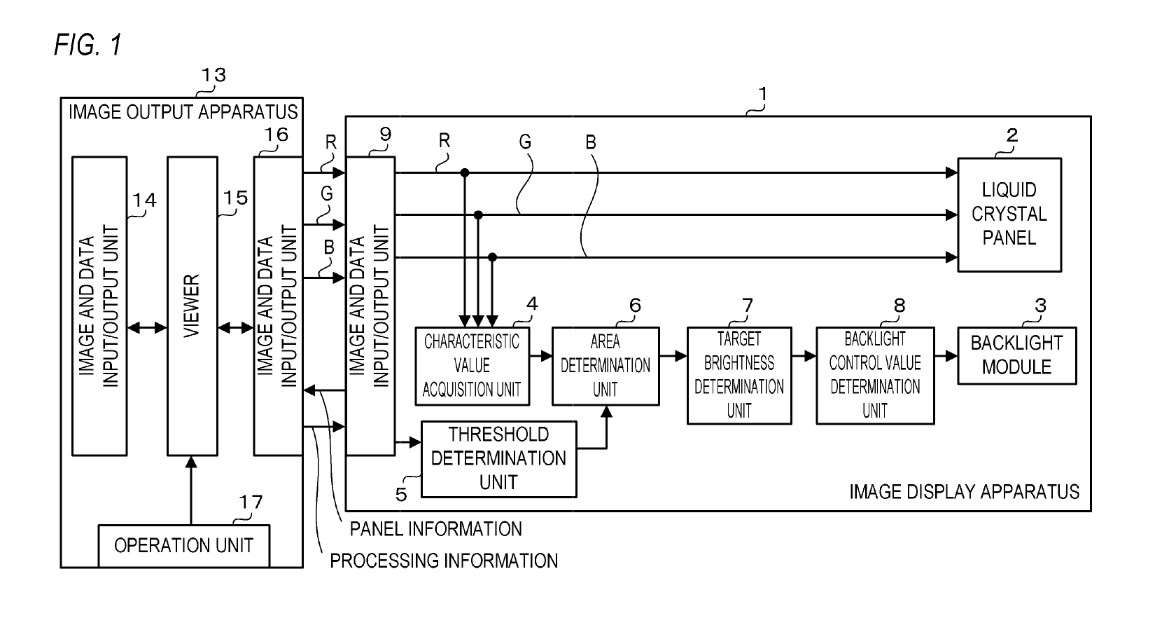

FIG. 1 is a block diagram depicting an example of a functional configuration of an image display system according to this example. As shown in FIG. 1, the image display system according to this example has an image display apparatus 1 and an image output apparatus 13. The image output apparatus 13 is a workstation, for example.

A configuration of the image display apparatus 1 will be described first.

The image display apparatus 1 can be connected to the image output apparatus 13 via a cable or wirelessly. In other words, the image output apparatus 13 can be connected to the image display apparatus 1 via a cable or wirelessly. In the case of the example in FIG. 1, the image display apparatus 1 and the image output apparatus 13 are connected with each other.

The image display apparatus 1 includes a liquid crystal panel 2, a backlight module 3, a characteristic value acquisition unit 4, a threshold determination unit 5, an area determination unit 6, a target brightness determination unit 7, a backlight control value determination unit 8, and an image and data input/output unit 9.

The image and data input/output unit 9 acquires input image data and processing information from the image output apparatus 13. The image and data input/output unit 9 outputs the input image data to the liquid crystal panel 2 and characteristic value acquisition unit 4, and outputs the processing information to the threshold determination unit 5. The processing information is information on the image processing that was executed when the input image data is generated.

The image and data input/output unit 9 outputs the panel information to the image output apparatus 13. The panel information is information that represents the size (resolution) of the screen of the image display apparatus 1.

The processing to acquire the input image data from the image output apparatus 13 (first acquisition processing) and the processing to acquire the processing information from the image output apparatus 13 (second acquisition processing) may be executed by different functional units respectively.

The backlight module 3 is an emission unit that includes a plurality of light sources, a drive circuit to drive each light source, and an optical unit to diffuse light from each light source. In this example, a light source is disposed in each of a plurality of divided areas (blocks) constituting the area of the screen. The plurality of blocks is, for example, an m (horizontal direction)×n (vertical direction) number of areas. One of m and n is 1 or greater integer, and the other of m and n is 2 or greater integer. A number of blocks is not limited to this, but in this example, it is assumed that 10 (horizontal direction)×7 (vertical direction), total 70 areas, are set as the plurality of blocks. Each light source has one or more light emitting elements. For the light emitting element, a light emitting diode, an organic EL element, a cold-cathode tube or the like can be used. The emission brightness of the plurality of light sources can be individually controlled. Each light source emits light at an emission brightness in accordance with the backlight control value determined by the backlight control value determination unit 8.

The liquid crystal panel 2 is a display unit that displays an image on the screen by modulating (transmitting) light from the backlight module 3. The liquid crystal panel 2 includes a plurality of liquid crystal elements, a liquid crystal driver and a control board. The liquid crystal driver drives each liquid crystal element. The control board controls the liquid crystal driver in accordance with the input image data. Therefore in this example, each liquid crystal element is driven in accordance with the input image data. In concrete terms, the transmittance of each liquid crystal element is controlled to a value in accordance with the input image data. An image in accordance with the input image data is displayed on the screen by the light from the backlight module 3 transmitting each liquid crystal element at a transmittance in accordance with the input image data.

Image data generated by executing a predetermined image processing on the input image data acquired by the image and data input/output unit 9 may be inputted to the liquid crystal panel 2. The predetermined image processing is, for example, brightness correction processing, color correction processing, shading processing, edge enhancement processing or frame rate conversion processing. For the predetermined image processing, image processing based on the emission brightness of each light source may be executed.

By the characteristic value acquisition unit 4, the threshold determination unit 5 and the area determination unit 6, an area of the background (background area) is detected from the area represented by the input image data. The background area is detected based on the gradation values of the input image data and processing information. The gradation values of the input image data are: R value, G value, B value, Y value, Cb value, Cr value or the like.

The characteristic value acquisition unit 4 acquires the characteristic value of the input image data in each block of the plurality of blocks. The characteristic value acquisition unit 4 outputs the characteristic value of each block to the area determination unit 6. The characteristic value is a histogram of the gradation values, or a representative value of the gradation values, for example. The representative value is a maximum value, a minimum value, a mean value, a mode, a median or the like. In this example, a case when the maximum value of the gradation values is acquired as the characteristic value will be described.

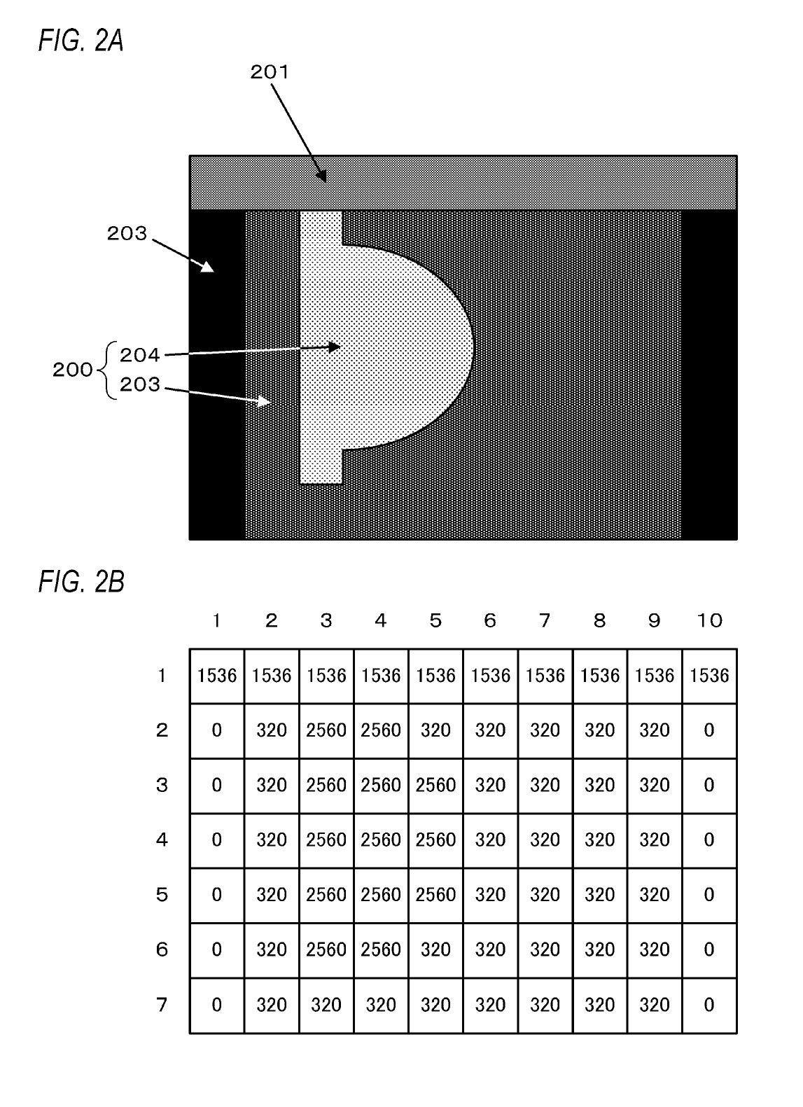

FIG. 2A and FIG. 2B show an example of the processing by the characteristic value acquisition unit 4.

FIG. 2A shows an image represented by the input image data (input image). In FIG. 2A, a gradation value is expressed with a color closer to white as the gradation value is greater, and with a color closer to block as the gradation value is lesser.

FIG. 2A shows a medical image (image for confirmation) 200, a graphic image 201 and a bar image 202, which are disposed in the input image. The medical image 200 is an x-rayed diagnostic image, for example. The area of the medical image 200 includes a background area 203 and an object area 204. The object area 204 is an area of an object (diagnosis target). The graphic image 201 is a menu image of a viewer to display and adjust the medical image 200. The bar image 202 is a solid black image.

FIG. 2B shows a characteristic value of each block acquired from the input image data that represents the input image in FIG. 2A. In FIG. 2B, each numeric value 1 to 10 in the horizontal direction indicates a position of the block in the horizontal direction (horizontal position), and each numeric value 1 to 7 in the vertical direction indicates a position of the block in the vertical direction (vertical position). FIG. 2B shows a case when each gradation value of the input image data is a 12-bit value (0 to 4095).

In the case of FIG. 2B, “2560” is acquired as a characteristic value of a block that includes at least a part of the object area 204.

“1536” is acquired as a characteristic value of a block that does not include the object area 204, but includes at least a part of the area of the graphic image 201.

“320” is acquired as a characteristic value of a block that does not include the object area 204 and the graphic image 201, but includes at least a part of the background area 203.

The other blocks are blocks that include only the area of the bar image 202. “0” is acquired as a characteristic value of a block that includes only the area of the bar image 202.

The image for confirmation is not limited to a medical image. The image for confirmation may be an illustration or an image of a digital photo.

The graphic image is not limited to a menu image.

The color of the bar image is not limited to black. The bar image may have a plurality of colors. A bar image with an illustration may be used.

A number of bits of a gradation value is not especially limited. The number of bits of a gradation value may be greater than or less than 12 bits.

The threshold determination unit 5 determines a gradation value of the background (background gradation value) as a background threshold based on the processing information. The threshold determination unit 5 outputs the determined background threshold to the area determination unit 6. In this example, information that represents a gradation value of a predetermined color that can be taken by the input image data is acquired. In concrete terms, information that represents a gradation value of the background of the input image data is acquired. Then the threshold determination unit 5 determines the gradation value represented by the processing information as a background threshold.

The predetermined color is not limited to the color of the background. The predetermined color may be black, red, green, blue, yellow, gray or the like. Then the gradation value of the background may be determined (calculated) based on the gradation value of the predetermined color.

The area determination unit 6 detects the background area based on the background threshold and characteristic value of each block. In concrete terms, for each block, the area determination unit 6 compares the characteristic value of this block and the background threshold, and determines whether this block is the background block or the object block based on the result. More specifically, the area determination unit 6 detects each block of which characteristic value is greater than the background threshold as the object block, and detects each block of which characteristic value is not greater than the background threshold as the background block. The object block is a block corresponding to the object area, and the background block is a block corresponding to the background area.

The area determination unit 6 outputs the determination result of each block to the target brightness determination unit 7.

A case when the input image is the image in FIG. 2A and the background threshold is “320” will be described as an example.

In this case, each block that includes at least a part of the object area 204 and each block that does not include the object area 204 but includes at least a part of the area of the graphic image 201 are detected as the object area. The other blocks are detected as the background area. In concrete terms, each block that does not include the object area 204 and the graphic image 201 but includes at least a part of the background area 203 and each block that includes only the area of the bar image 202 are detected as the background area.

The area detection method is not limited to this method. For example, an area of which gradation value matches with the background threshold may be detected as the background area. And a block that includes only the background area may be detected as the background block.

When the image based on the input image data is displayed on the screen, the emission brightness of each light source is controlled by the target brightness determination unit 7 and the backlight control value determination unit 8 based on the background area detection result.

The target brightness determination unit 7 determines the target brightness of each light source based on the background area detection result (determination result by the area determination unit 6). The target brightness is a target value of the emission brightness. In this example, the target brightness determination unit 7 sets a first level as a target brightness of the light sources disposed in an area other than the background area, and sets a second level as a target brightness of the light sources disposed in the background area. In concrete terms, the target brightness determination unit 7 sets the first level as a target brightness of the light sources disposed in the object block, and sets the second level as a target brightness of the light sources disposed in the background block. The second level is lower than the first level.

The target brightness determination unit 7 outputs the target brightness of each light source to the backlight control value determination unit 8.

The first level and the second level are not especially limited. For example, if the value (brightness) that is 1/10 of the first level is used as the second level, the contrast of the display image (image displayed on the screen) can be enhanced 10 times.

For each light source, the backlight control value determination unit 8 determines a backlight control value of this light source in accordance with the target brightness of the light source. Then the backlight control value determination unit 8 outputs the backlight control value of each light source to the backlight module 3. Thereby the emission brightness of each light source is controlled to the emission brightness in accordance with the backlight control value (target brightness). In other words, the emission brightness of the light sources disposed in an area other than the background area is controlled to the first level, and the emission brightness of the light sources disposed in the background area is controlled to the second level. In concrete terms, the emission brightness of the light sources disposed in the object block is controlled to the first level, and the emission brightness of the light sources disposed in the background block is controlled to the second level.

The backlight control value may be any value. For example, a pulse width (lighting time of the light source) may be used as the backlight control value if a pulse width modulation method is used to control the emission brightness of the light source. If a pulse amplitude modulation method is used to control the emission brightness of each light source, the pulse amplitude may be used as the backlight control value. If both the pulse width and the pulse amplitude are modulated to control the emission brightness of each light source, a combination of the pulse width and the pulse amplitude may be used as the backlight control value.

The image output apparatus 13 will be described next.

The image output apparatus 13 includes an image and data input/output unit 14, a viewer 15, an image and data input/output unit 16 and an operation unit 17.

The image and data input/output unit 14 acquires image data (medical image data, image data for confirmation, original image data) that represents a medical image (image for confirmation) from the outside. In concrete terms, the image and data input/output unit 14 is connected to a server (not illustrated) for storing medical image data generated by photography, photographing information of medical image data or the like, via a network in a hospital. If a patient is specified (selected) in the viewer 15, which will be described later, information (patient information) on the specified patient is notified from the viewer 15 to the image and data input/output unit 14. Then the image and data input/output unit 14 notifies the patient information to the server, and acquires the medical image data and photographing information corresponding to the specified patient from the server. The image and data input/output unit 14 outputs the acquired medical image data and the photographing information to the viewer. The medical image data corresponding to the specified patient is medical image data generated by photographing the specified patient. The photographing information includes the photographing conditions and the development information (information required for development).

The operation unit 17 accepts the user operation. For the operation unit 17, a keyboard, a mouse, buttons disposed on a case of the image output apparatus 13 or the like can be used. The user can operate the image output apparatus 13 by executing operation using a GUI image display on the screen of the image display apparatus 1. The operation unit 17 outputs the operation information, that represents the executed user operation, to the viewer 15.

The viewer 15 is an image processing unit that generates input image data from medical image data (original image data) by executing image processing. The viewer 15 outputs the generated input image data and the processing information that represents the image processing, which was executed to generate this input image data, to the image and data input/output unit 16.

In this example, the viewer 15 specifies a patient in accordance with the user operation to specify a patient, and notifies the patient information to the image and data input/output unit 14 (this will be described in detail later). The viewer 15 also generates input image data from the medical image data outputted from the image and data input/output unit 14 by executing the image processing in accordance with the user operation on the image processing and combining processing. The combining processing is a processing to combine image data that represents an image where the graphic image is disposed. For this, in this example, input image data that represents the image, where the graphic image is disposed, is generated. The user operation can be recognized by the operation information outputted from the operation unit 17.

The image and data input/output unit 16 outputs the input image data and the processing information to the image display apparatus 1. The input image data and the processing information may be individually transmitted or may be transmitted in tandem. In the case of using an interface conforming to a display port standard, the processing information may be transmitted using an AUX channel specified in a display port standard. The processing information may be attached to the input image data as metadata.

The image and data input/output unit 16 acquires the panel information from the image display apparatus 1, and outputs the acquired panel information to the viewer 15.

The processing to output the input image data to the image display apparatus 1 (first output processing) and the processing to output the processing information to the image display apparatus 1 (second output processing) may be executed by different functional units respectively.

The viewer 15 will be described in detail.

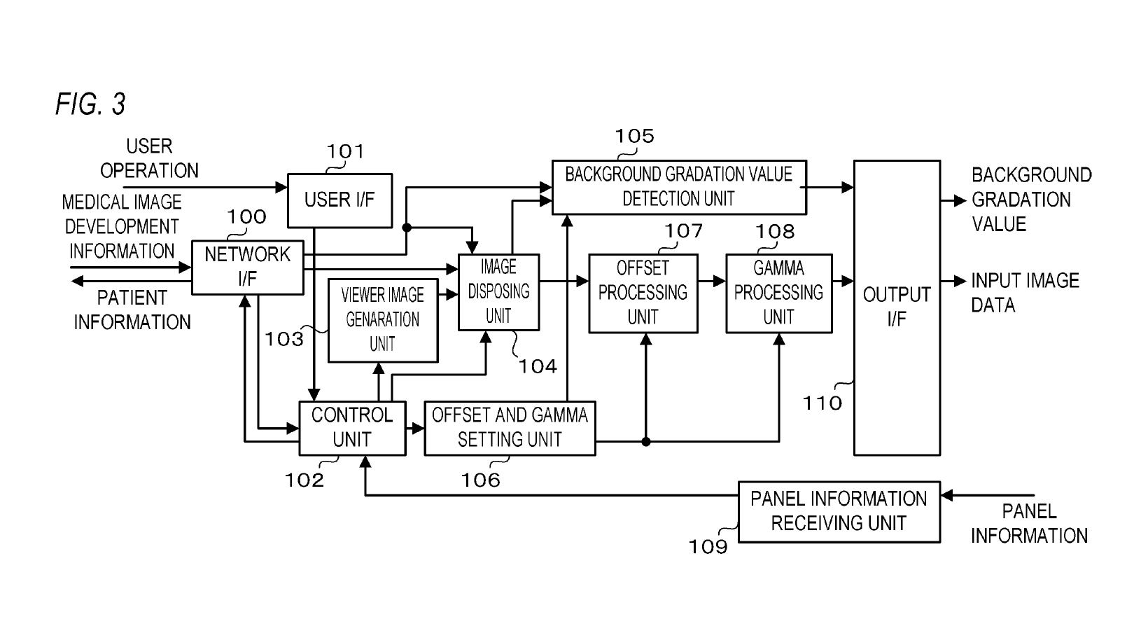

FIG. 3 is a block diagram depicting an example of a functional configuration of the viewer 15.

As shown in FIG. 3, the viewer 15 includes a network I/F 100, a user I/F 101, a control unit 102, a viewer image generation unit 103, an image disposing unit 104, a background gradation value detection unit 105, an offset and gamma setting unit 106, an offset processing unit 107, a gamma processing unit 108, a panel information receiving unit 109 and an output I/F 110.

The network I/F 100 outputs the patient information outputted from the control unit 102 to the image and data input/output unit 14. The network I/F 100 also acquires the medical image data and the photographing information from the image and data input/output unit 14. The network I/F 100 outputs the acquired medical image data to the image disposing unit 104, and outputs the acquired photographing information to the background gradation value detection unit 105.

The network I/F 100 may also acquire image information from a server via the image and data input/output unit 14. The network I/F 100 may output the medical image data and the image information to the image disposing unit 104. The image information is information that represents the size of the medical image, for example.

The user I/F 101 acquires operation information from the operation unit 17, and outputs the operation information to the control unit 102. For example, if a user operation to select an operation item indicated in the menu image is executed, the operation information on the selected operation item is acquired. If a user operation to change a parameter value to be used for image processing to generate the input image data is executed, operation information on the updated parameter value is acquired.

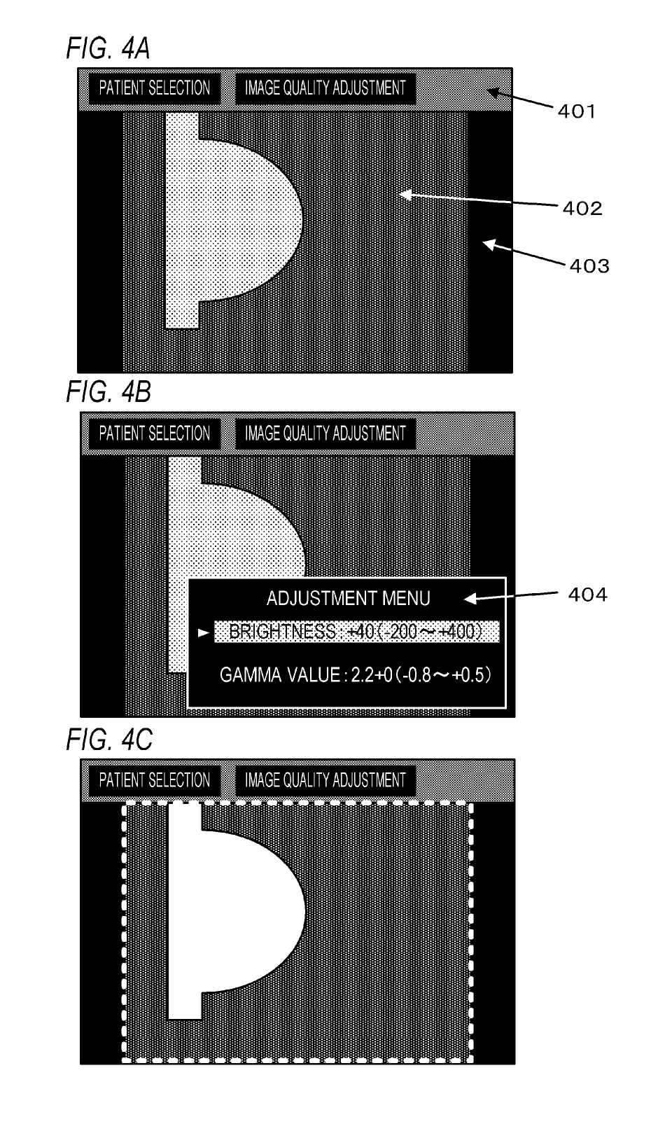

An example of the operation information will be described with reference to FIG. 4A and FIG. 4B.

FIG. 4A and FIG. 4B show an example of an input image. In FIG. 4A and FIG. 4B, a graphic image 401, a medical image 402 and a bar image 403 are disposed in the input image. The graphic image 401 is a menu image (GUI image) showing operation items of the viewer.

If a user operation to select an operation item is executed when the input image in FIG. 4A is displayed, operation information represented by the selected operation item is notified to the control unit 102. If the selected operation item is “image quality adjustment”, the operation information is notified to the control unit 102, then various processing are executed. As a result, a sub-graphic image 404, which is one graphic image, is also displayed (FIG. 4B). The sub-graphic image 404 is a sub-menu image (GUI image) that indicate parameter values used for image processing. In the case of FIG. 4B, a “brightness (offset value)” and a “gamma value” are displayed as parameter values in the sub-graphic image 404. Furthermore, in the case of FIG. 4B, a current parameter value and a range of parameter values that can be set are displayed in the sub-graphic image 404. The user can change the parameter values using the sub-graphic image 404. The operation item “patient selection” is selected when the user selects a patient.

If a user operation to change the parameter values is executed when the input image in FIG. 4B is displayed, the operation information to indicate the updated parameter values is notified to the control unit 102. For example, if the value of “brightness” is changed to “+20”, then the operation information that the value of “brightness” is changed to “+20” is notified to the control unit 102.

The panel information receiving unit 109 acquires (receives) the panel information from the image display apparatus 1 via the image and data input/output unit 16. The panel information receiving unit 109 outputs the acquired panel information to the control unit 102.

The control unit 102 executes processing in accordance with the operation information outputted from the user I/F 101.

For example, if the user operation to specify a patient is executed, the control unit 102 specifies a patient in accordance with the user operation, and outputs the patient information that represents the specified patient to the network I/F 100.

If the user operation to select an operation item is executed, the control unit 102 outputs a generation instruction to generate viewer image data, where a sub-graphic image item corresponding to the selected operation item is disposed, to the viewer image generation unit 103. The viewer image data is image data that represents an image (viewer image) where the graphic image, the bar image, the sub-graphic image and the like are disposed. The viewer image can also be interpreted as an original image where the medical image is not included.

If the user operation to change a parameter value is executed, the control unit 102 outputs the updated parameter value to the offset and gamma setting unit 106.

If the user operation to change the image format of the medical image data (original image data) is executed, the control unit 102 outputs the format information that represents the updated image format to the image disposing unit 104. The image format is, for example, RAW format, BITMAP format or TIFF format.

The control unit 102 acquires panel information from the panel information receiving unit 109. Based on the panel information, the control unit 102 generates the size information to represent the size (resolution) of the viewer image, disposition information to represent the disposition of the viewer image and the medical image or the like. Then the control unit 102 outputs the generated information (e.g. size information, disposition information) to the image disposing unit 104. The size information is also outputted to the viewer image generation unit 103.

Based on the size information outputted from the control unit 102, the viewer image generation unit 103 generates the viewer image data to represent the viewer image, and outputs the generated viewer image data to the image disposing unit 104. In concrete terms, viewer image data to represent a viewer image, in which the image size indicated by the size information and the image size are the same, is generated and outputted. In this example, viewer image data to represent a viewer image, in which the graphic image and the bar image are disposed, is normally generated. If the generation instruction is outputted from the control unit 102, viewer image data to represent a viewer image, in which a sub-graphic image is also disposed, is generated.

Image processing and combining processing are executed by the image disposing unit 104, the offset processing unit 107 and the gamma processing unit 108. Thereby the input image data is generated from the original image data. In this example, the format conversion processing, the offset processing and the gamma conversion processing are executed as the image processing.

For the image processing, a processing other than the format conversion processing, the offset processing and the gamma conversion processing may be executed. Any one of the format conversion processing, the offset processing and the gamma conversion processing may be omitted.

The image disposing unit 104 acquires the medical image data (original image data) from the network I/F 100, and acquires the viewer image data from the viewer image generation unit 103. The image disposing unit 104 also acquires the size information, the disposition information, the format information or the like from the control unit 102.

The image disposing unit 104 combines the medical image data and the viewer image data based on the disposition information outputted from the control unit 102, whereby the combined image data, where the medical image is disposed in the viewer image, is generated. Then the image disposing unit 104 outputs the generated combined image data to the offset processing unit 107.

When the combined image data is generated, the image disposing unit 104 executes the format conversion processing to convert the image format of the medical image data, or executes the size conversion processing to convert the image size of the medical image data, if necessary. In concrete terms, the image format of the medical image data is converted based on the format information outputted from the control unit 102. Specifically, the image format of the medical image data is converted to the image format represented by the format information. Moreover, the image size of the medical image data is converted based on the size information and the disposition information outputted from the control unit 102. Then the image disposing unit 104 generates the combined image data using the medical image data after conversion.

It is preferable that the image size of the medical image data is converted while maintaining the aspect ratio of the medical image data.

An example of the format conversion processing will be described.

Here a case when the medical image data (original image data) acquired by the network I/F 100 is RAW image data, and the image formats that the user can select are RAW format and DICOM format, will be described. The DICOM format is an image format conforming to the DICOM (Digital Imaging and Communications in Medicine) standard. The DICOM standard is an international standard for the communication and management of medical images, such as radiographs and ultrasound images.

If the RAW format is selected by the user operation, the image disposing unit 104 generates the combined image data without converting the image format of the medical image data.

If the DICOM format is selected by the user operation, the image disposing unit 104 converts the image format of the medical image data from the RAW format into the DICOM format, and generates the combined image data. In concrete terms, the image disposing unit 104 acquires the photographing information from the network I/F 100, and executes the development processing on the medical image data based on the acquired photographing information. Thereby the format of the medical image data is converted from the RAW format into the DICOM format.

The offset and gamma setting unit 106 stores an offset value and a gamma value as the parameter values. If an updated parameter value is outputted from the control unit 102, the offset and gamma setting unit 106 updates the stored parameter value to a parameter value outputted from the control unit 102. The offset and gamma setting unit 106 outputs the stored offset value to the offset processing unit 107, and outputs the stored gamma value to the gamma processing unit 108. In the example of FIG. 4B, “+20” is specified as the offset value, and “2.2” is specified as the gamma value. In this case, “+20” is outputted to the offset processing unit 107, and “2.2” is outputted to the gamma processing unit 108. The offset and gamma setting unit 106 also outputs the stored parameter values (offset value and gamma value) to the background gradation value detection unit 105.

The offset processing unit 107 acquires the offset value from the offset and gamma setting unit 106, and acquires the combined image data from the image disposing unit 104. The offset processing unit 107 executes the offset processing to add an offset value to the gradation value of the combined image data. The offset processing is executed only on the medical image area (photographed image area). The medical image area is an area enclosed by the broken line in FIG. 4C. In other words, the medical image area is an area created for the medical images. By this [offset processing], first processed image data is generated. The offset processing unit 107 outputs the first processed image data to the gamma processing unit 108.

The gamma processing unit 108 acquires the gamma value from the offset and gamma setting unit 106, and acquires the first processed image data from the offset processing unit 107. The offset processing unit 107 executes gamma conversion processing using the gamma value acquired from the offset and gamma setting unit 106 on each gradation value of the original image data. The gamma conversion processing is also executed only on the medical image area. Thereby second processed image data (input image data) is generated. The gamma processing unit 108 outputs the input image data to the output I/F 110.

At least one of the offset processing and the gamma conversion processing may be executed on the medical image data before executing the combining processing. For example, after executing the format conversion processing, the size conversion processing, the offset processing and the gamma conversion processing on the medical image data, which is the original image data, the combining processing to combine the processed medical image data and the viewer image data, may be executed. One of the offset processing and the gamma conversion processing may be executed before the combining processing, and the other may be executed after the combining processing.

The background gradation value detection unit 105 acquires the photographing information from the network I/F 100, and acquires the format information from the control unit 102. The background gradation value detection unit 105 also acquires parameter values (offset value and gamma value) from the offset and gamma setting unit 106.

The background gradation value detection unit 105 determines a background gradation value using the acquired information, and outputs the determined background gradation value to the output I/F 110 as the processing information.

The background gradation value detection unit 105 determines a reference value of the background gradation value based on the photographing information and the format information.

If the image format is not converted by the image disposing unit 104, the background gradation value detection unit 105 determines the reference value of the gradation value of the background based on the photographing information. For example, the photographing information includes energy intensity of radiation and setting value of the sensitivity of an imaging plate or the like. The background gradation value detection unit 105 calculates the reception intensity in the background based on the energy intensity of radiation, the setting value of the sensitivity of the imaging plate or the like. Then the background gradation value detection unit 105 determines the reference value in accordance with the calculated reception intensity.

If the image format is converted by the image disposing unit 104, the background gradation value detection unit 105 determines the reference value of the gradation value of the background using the development information included in the photographing information. For example, the reference value is determined by the above mentioned processing using the photographing information, and the determined reference value is corrected based on the development information.

Then the background gradation value detection unit 105 determines the background gradation value by correcting the reference value based on the parameter values. For example, if the reference value is “25”, the offset value is “0” and the gamma value is “1”, then 25 (=25+0) is acquired as the background gradation value. If the reference value is “25”, the offset value is “+20” and the gamma value is “1”, then 45 (=25+20) is acquired as the background gradation value.

The method for determining the background gradation value is not limited to the above mentioned method. For example, as the reference value, the maximum value of the background gradation value may be acquired from the medical image data (original image data) by executing image analysis. Then the background gradation value may be determined by correcting the acquired reference value based on the development information or the parameter values. The image output apparatus can use original image data, which is image data before executing the image processing (e.g. format conversion processing, offset processing, gamma processing). If the original data is used, the background area can be very accurately detected, therefore the reference value of the background gradation value can be very accurately determined as well.

The output I/F 110 outputs the input image data outputted from the gamma processing unit 108 and the processing information (background gradation value) outputted from the background gradation value detection unit 105 to the image display apparatus 1 via the image and data input/output unit 16.

In this example, even if the gradation values of the input image data are changed due to a change in the image format of the original image data, or a change in the parameter values of the image processing, the emission brightness of each light source can be accurately control led because of this configuration based on the background area detection result. For example, the background area (background block) can be very accurately detected, and the contrast of the display image can be enhanced by dropping the emission brightness of the light sources disposed in the background area.

The operation and the effect of this example will be described with specifics. An example when the gradation values of the input image data are 12-bit values (0 to 4095) will be described.

First an example when the input image data that represents the input image in FIG. 2A is generated will be described.

Here it is assumed that the offset value is “0” and the gain value is “1”. It is also assumed that “320” is acquired as the background gradation value by the background gradation value detection unit 105.

In this case, the characteristic value acquisition unit 4 acquires the characteristic values shown in FIG. 2B.

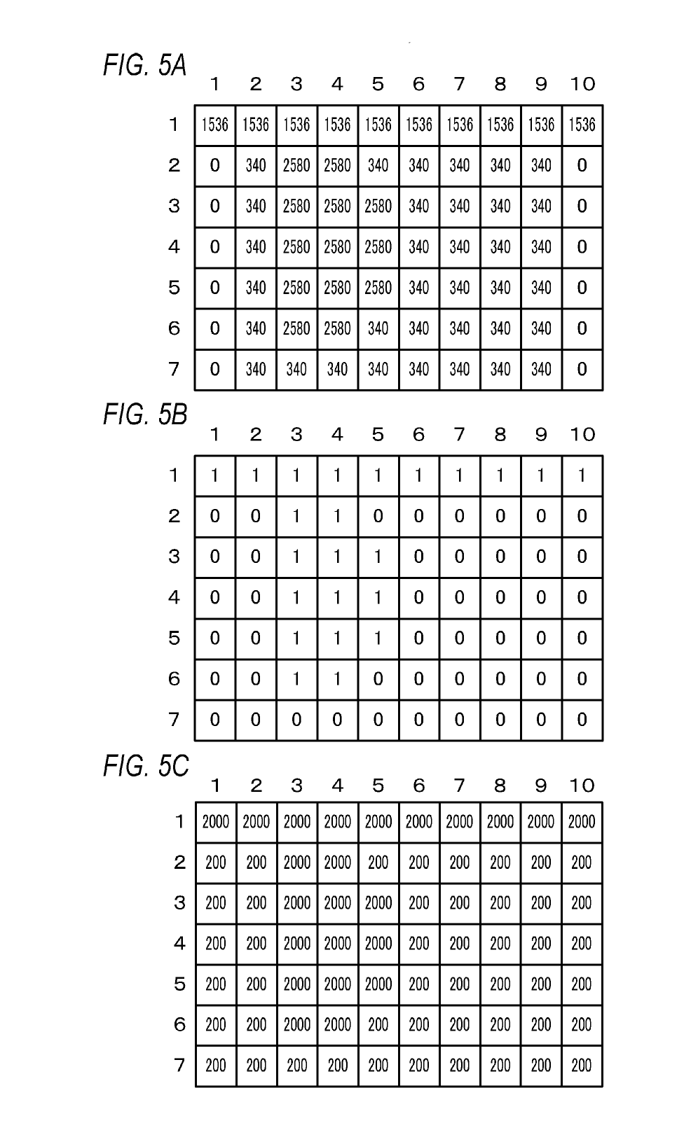

Then the area determination unit 6 detects each block of which characteristics value is greater than “320” as an object block, and detects each block of which characteristic value is “320” or less as the background block. In concrete terms, the result shown in FIG. 5B is acquired as the determination result (detection result) by the area determination unit 6. In FIG. 5B, “1” indicates an object block and “0” indicates a background block.

Then the emission brightness of the light sources in the object block is controlled to a first level, and the emission brightness of the light sources in the background block is controlled to a second level. If the first level is 2000 [cd/m²] and the second level is 200 [cd/m²], then the emission brightness of each light source is controlled as shown in FIG. 5C.

If a value 1/10 of the first level is used as the second level, the contrast of the display image can be enhanced by 10 times.

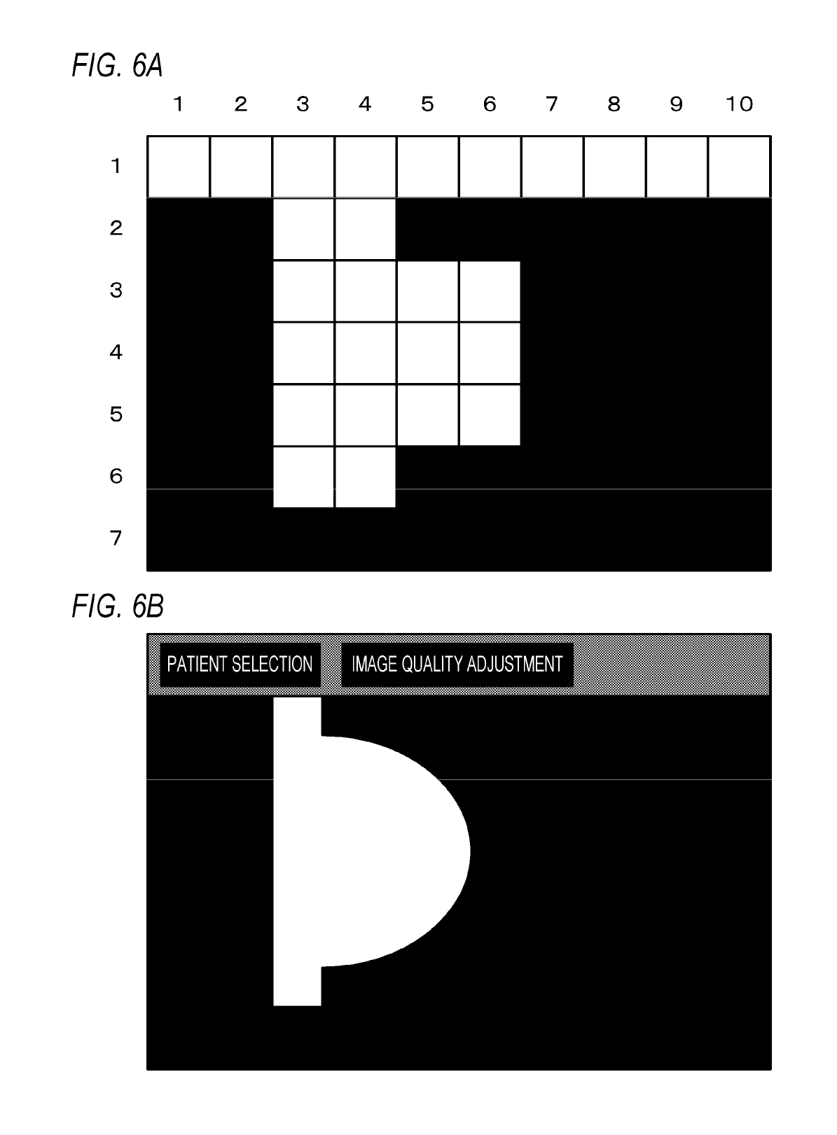

FIG. 6A shows a lighting image of the backlight module 3 of each light source when each light source emits light at the emission brightness shown in FIG. 5C. In FIG. 6A, the emission brightness is expressed by a color closer to white as the emission brightness is higher, and by a color closer to black as the emission brightness is lower. As shown in FIG. 6A, according to this example, the emission brightness of the light sources is controlled to a high level in the object area and the graphic image area, and is controlled to a lower value in the background area and the bar image area. Therefore a display image having high contrast can be acquired as shown in FIG. 6B.

An example when the offset value is increased from “0” to “+20” will be described next. The gamma value is not changed, it is still “1”.

In this case, the control unit 102 notifies the offset and gamma setting unit 106 that the offset value is “+20”. Then the offset and gamma setting unit 106 outputs the offset value “+20” to the offset processing unit 107 and the background gradation value detection unit 105. The background gradation value detection unit 105 adds the offset value “+20” to the reference value “320”, whereby the background gradation value “340” is calculated. The background gradation value “340” is inputted to the threshold determination unit 5. The threshold determination unit 5 determines the background gradation value “340” as the background threshold, and outputs the determined background threshold “340” to the area determination unit 6.

Since the offset value is increased by “+20”, the characteristic value acquisition unit 4 acquires each characteristic value generated by adding the offset value “+20” to each value shown in FIG. 2B. In other words, each characteristic value acquired by the characteristic value acquisition unit 4 changes the value shown in FIG. 2B to the value shown in FIG. 5A, since the offset value is increased by “+20”.

The background threshold is changed from “320” to “340”, therefore a result the same as the case when the offset value is “0” (result shown in FIG. 5B) can be acquired as the determination result by the area determination unit 6. As a result, the emission brightness of each light source can be controlled to a value the same as the case when the offset value is “0” (each value shown in FIG. 5C).

In this way, according to this example, the background block can be very accurately detected, and the emission brightness of each light source can be properly controlled, even if the image format or parameter value is changed. In concrete terms, even if the offset value is increased to “+20”, the emission brightness of each light source can be controlled in the same way as the case when the offset value is “0”. In other words, as shown in FIG. 6A, the emission brightness of the light sources disposed in the object area and the graphic image area can be controlled to a high value, and the emission brightness of the light sources disposed in the background area and the bar image area can be controlled to a low value. As a result, a display image having high contrast can be acquired even if the offset value is increased to “+20”.

As described above, according to this example, not only the input image data but also the processing information is outputted from the image output apparatus to the image display apparatus. In the image display apparatus, the background area is detected using not only the gradation values of the input image data but also the processing information. In other words, according to this example, the background area is detected considering not only the gradation values of the input image data, but also the image processing executed to generate the input image data. Therefore even if the gradation values of the input image data are changed, a background area can be very accurately detected. As a result, the emission brightness of each light source can be properly controlled based on the background area detection result.

In this example, the example when the processing information is information that represents the background gradation value was described, but [the present invention] is not limited to this. For example, the image output apparatus may output the development information or information including the parameter values as the processing information. And the image display apparatus may determine the background threshold based on the development information and the parameter values. If at least one of the offset processing and the gamma processing is executed as the image processing, the image output apparatus may output at least one of the offset value and the gamma value as the processing information. The image display apparatus may determine the background threshold based on at least one of the offset value and the gamma value.

In this example, an example when not only the object area but also the graphic image area (graphic area) is detected as the object area was described, but [the present invention] is not limited to this.

For example, an area information that represents the graphic image area in the input image area may be further outputted from the image and data input/output unit 16 of the image output apparatus 13 to the image display apparatus 1. The processing to output the area information (third output processing) may be executed by a functional unit that is different from the function unit to execute the first output processing and the second output processing.

The image and data input/output unit 9 of the image display apparatus 1 may further acquire the area information from the image output apparatus 13. The processing to acquire the area information (third acquisition processing) may be executed by a functional unit that is different from the functional unit to execute the first acquisition processing and the second acquisition unit.

The target brightness of each light source may be determined based on the background area detection result and the area information and the emission brightness of each light source may be controlled to the target brightness. In other words, the emission brightness of each light source may be controlled based on the background area detection result and the area information.

If the emission brightness of the light sources in the graphic area is too high and the background area exists near the graphic area, the light from the light sources in the graphic area leaks into the background area, and the contrast of the display image drops. Particularly when the emission brightness of each light source in the graphic area is higher than the emission brightness of the light sources in the background area, the drop in contrast due to the leaked light stands out more as the difference of the emission brightness there between is larger. In concrete terms, black floating is generated in the background area more frequently as the difference of the emission brightness is larger, and contrast drops more as the difference of the emission brightness is larger.

If the emission brightness of each light source in the graphic area is too low, the visibility of the graphic image deteriorates. Particularly when the emission brightness of the light sources in the graphic area is lower than the emission brightness of the light sources in the object area, the visibility of the graphic image deteriorates more as the difference of the emission brightness there between is larger. This deterioration in visibility is generated by the user comparing the bright object area and the dark graphic area. In concrete terms, this deterioration in visibility is generated due to human visual characteristics, for when both a bright object and a dark object enter the visual field of an individual, the dark object becomes difficult to see.

Therefore it is preferable to set a first level as the target brightness of the light sources disposed in an area (object area) other than the background area and the graphic area. It is preferable to set a second level, which is lower than the first level, as the target brightness of the light sources disposed in the background area. And it is preferable to set a third level, which is a level between the first level and the second level, as the target brightness of the light sources disposed in the graphic area. It is particularly preferable that the third level is one-half of the first level.

If the target brightness levels are set in this way, the emission brightness of the light sources disposed in the object area is controlled to the first level. The emission brightness of the light sources disposed in the background area is controlled to the second level. And the emission brightness of the light sources disposed in the graphic image area is controlled to the third level.

By controlling the emission brightness of each light source in this way, the deterioration in visibility of the graphic image can be suppressed, and contrast of the display image can be enhanced.

The values of the emission brightness, the number of light sources, the contrast improvement ratio or the like, described in this example, are merely examples, and are not intended to limit [the present invention]. For example, the contrast improvement ratio (target value) may be determined in accordance with the operation by the user.

The graphic image and the bar image may not be disposed in the input image data. For example, the input image data may be generated by executing image processing (e.g. format conversion processing, offset processing, gamma conversion processing) on the original image data, without performing the combining processing.

The first level, the second level and the third level may be predetermined fixed values, or may be values which the user can change.

The method for controlling the emission brightness of each light source is not especially limited. The emission brightness of each light source may be controlled in any way as long as the emission brightness of each light source can be controlled based on the background area detection result.

### Example 2

An image display apparatus, an image output apparatus and control methods thereof according to Example 2 of the present invention will now be described.

In Example 1, the image output apparatus notifies the processing information to the image display apparatus, and the image display apparatus detects the background area and determines the target brightness.

In Example 2, the image output apparatus also executes the processing to detect the background area and the processing to determine the target brightness. Moreover, in this example, the graphic area is separately handled from the object area to determine the target brightness of each light source.

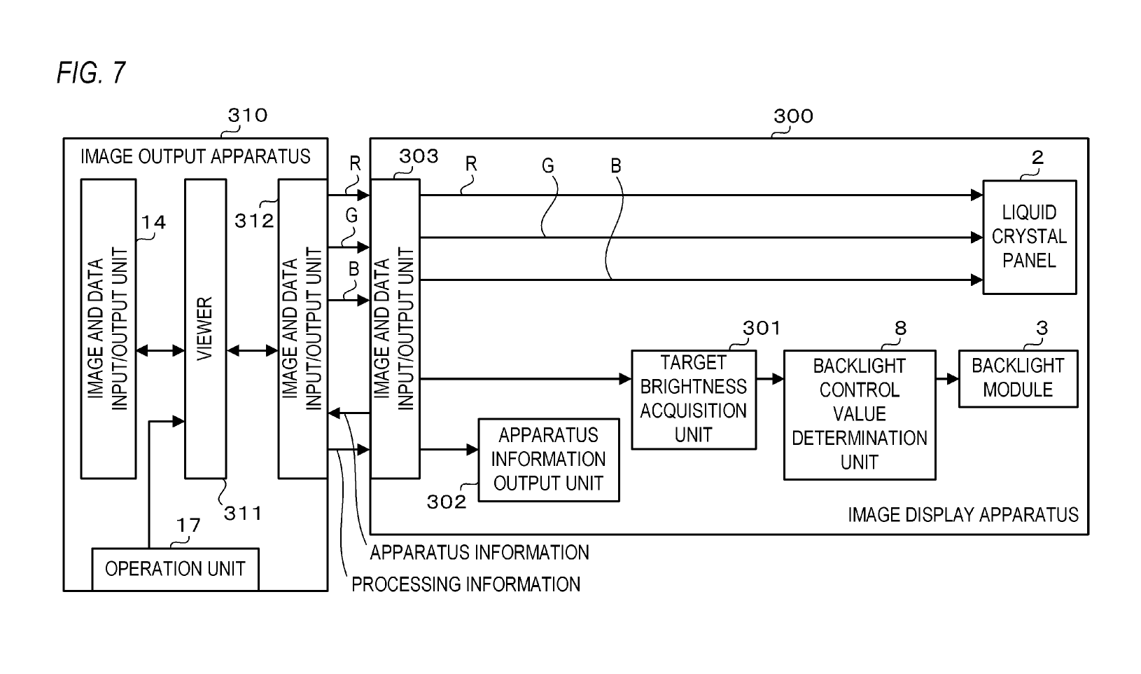

FIG. 7 is a block diagram depicting an example of a functional configuration of an image display system according to this example. As shown in FIG. 7, the image display system according to this example has an image display apparatus 300 and an image output apparatus 310.

In FIG. 7, a functional unit the same as Example 1 is denoted with a same reference numeral as Example 1, for which description is omitted.

First the image display apparatus 300 will be described.

The image display apparatus 300 includes a liquid crystal panel 2, a backlight module 3, a backlight control value determination unit 8, a target brightness acquisition unit 301, an apparatus information output unit 302, and an image and data input/output unit 303.

The image and data input/output unit 303 acquires input image data and target brightness information from the image output apparatus 310. The target brightness information is information that represents the target brightness of each light source. The image and data input/output unit 303 outputs the input image data to the liquid crystal panel 2, and outputs the target brightness information to the target brightness acquisition unit 301.

The image and data input/output unit 303 also acquires the apparatus information from the apparatus information output unit 302, and outputs the acquired apparatus information to the image output apparatus 310. The apparatus information is panel information, light source information or the like. The light source information is information that represents a number of light sources (blocks), size and disposition of the light sources or the like.

The processing to acquire the input image data from the image output apparatus 310 (first acquisition processing) and the processing to acquire the target brightness information from the image output apparatus 310 (fourth acquisition processing) may be executed by different functional units respectively.

The target brightness acquisition unit 301 outputs the target brightness information outputted from the image and data input/output unit 303 to the backlight control value determination unit 8.

The apparatus information output unit 302 outputs the apparatus information, which is provided in advance, to the image and data input/output unit 303.

Next the image output apparatus 310 will be described.

The image output apparatus 310 includes an image and data input/output unit 14, an operation unit 17, a viewer 311 and an image and data input/output unit 312.

The viewer 311 generates input image data from medical image data (original image data) by executing at least one image processing. The input image data generation method is the same as Example 1.

The viewer 311 also executes the background detection processing and the target brightness determination processing. The background detection processing is processing to detect the background area in the area of the input image. The background area can be detected based on the gradation values of the original image data. The background area may be detected based on the gradation values of the processed image data and the processing information which is information on image processing executed when the processed image data was generated. The processed image data is image data generated from the original image data by executing a part or all of at least one image processing. The target brightness determination processing is processing to determine the target brightness of each light source based on the result of the background detection processing (background area detection result).

The viewer 15 outputs the generated input image data and the target brightness information (result of the target brightness determination processing) to the image and data input/output unit 312.

The image and data input/output unit 312 outputs the input image data and the target brightness information to the image display apparatus 300. The input image data and the target brightness information may be independently transmitted or may be transmitted in tandem. In the case of using an interface conforming to a display port standard, the target brightness information may be transmitted using an AUX channel specified in the display port standard. The target brightness information may be attached to the input image data as metadata.

The image and data input/output unit 312 acquires the apparatus information from the image display apparatus 300, and outputs the acquired apparatus information to the viewer 311.

The processing to output the input image data to the image display apparatus 300 (first output processing) and the processing to output the target brightness information to the image display apparatus 300 (fourth output processing) may be executed by different functional units respectively.

The viewer 311 will be described in detail.

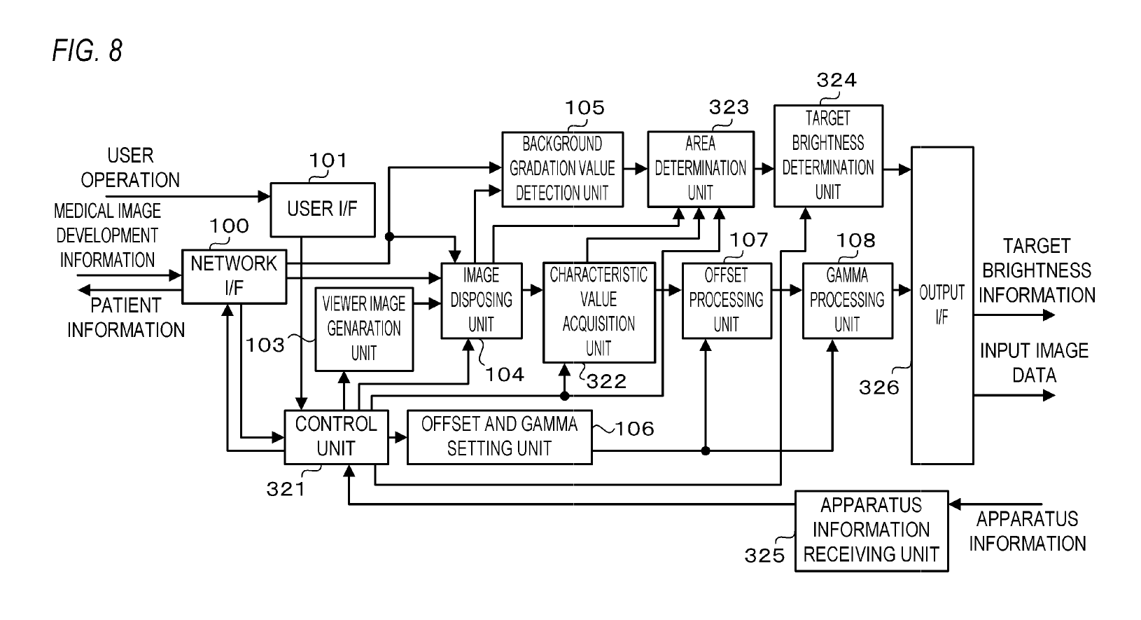

FIG. 8 is a block diagram depicting an example of a functional configuration of the viewer 311.

As shown in FIG. 8, the viewer 311 includes a network I/F 100, a user I/F 101, a control unit 321, a viewer image generation unit 103, an image disposing unit 104, a background gradation value detection unit 105, an offset and gamma setting unit 106, a characteristic value acquisition unit 322, an offset processing unit 107, a gamma processing unit 108, an area determination unit 323, a target brightness determination unit 324, an apparatus information receiving unit 325, and an output I/F 326.

The apparatus information receiving unit 325 acquires (receives) apparatus information from the image display apparatus 300 via the image and data input/output unit 312. Then the apparatus information receiving unit 325 outputs the acquired apparatus information to the control unit 321.

The control unit 321 has a function similar to the control unit 102 of Example 1.

Furthermore, the control unit 321 determines a first level which is a target brightness of the object area, a second level which is a target brightness of the background area, and a third level which is a target brightness of the graphic area. In this example, the first level and the second level are determined based on the set values of the display brightness and the contrast. Then a level that is one-half of the first level is determined as the third level. The control unit 321 outputs the determined target brightness levels (first level, second level, third level) to the target brightness determination unit 324.

The control unit 321 outputs the light source information, included in the apparatus information outputted from the apparatus information receiving unit 325, to the characteristic value acquisition unit 322 and the area determination unit 323.

At least one of the set values of the display brightness and the contrast may be determined in accordance with the user operation, or may be determined in accordance with the environment where the image display apparatus is installed. At least one of the set values of the display brightness and the contrast may be included in the apparatus information. At least one of the set values of the display brightness and the contrast may be a fixed value determined in advance.

The first level, the second level and the third level may be fixed values determined in advance, or may be values which can be changed by the user.

The characteristic value acquisition unit 322 acquires the combined image data from the image disposing unit 104, and acquires light source information from the control unit 321. The combined data is image data that includes processed image data generated by executing the format conversion processing on the original image data, or image data that includes the original image data.

The characteristic value acquisition unit 322 acquires a number of light sources (blocks), size and disposition thereof or the like from the light source information. Then, for each of the plurality of blocks, the characteristic value acquisition unit 322 acquires the characteristic value of the combined image data in the block. The characteristic value acquisition unit 322 outputs the characteristic value of each block to the area determination unit 323.

The area determination unit 323 acquires the background gradation value (processing information) from the background gradation value detection unit 105, and acquires the characteristic value of each block from the characteristic value acquisition unit 322. The area determination unit 323 also acquires the light source information from the control unit 321, and acquires, from the image disposing unit 104, the area information that represents the area of the graphic image in the area of the input image. In this example, a value the same as the reference value, which is determined considering the image format, is acquired as the background gradation value. Therefore the background gradation value indicates the gradation value of the background of the combined image data (gradation value of the background of the original image data, or the gradation value of the background of the processed image data).

The area determination unit 323 detects a number of light sources (blocks), size and disposition thereof or the like based on the light source information. The area determination unit 323 determines the background threshold based on the background gradation value using the same method as Example 1. Then the area determination unit 323 detects the background area based on the background threshold and the characteristic value of each block using the same method as Example 1. In concrete terms, it is determined whether this block is a background block or an object block for each block. A block that includes an area represented by the area information is determined as a graphic block (block corresponding to the graphic area).

The area determination unit 323 outputs the determination result of each block to the target brightness determination unit 324.

A block that includes only the area represented by the area information may be set as a graphic block, or a block that includes at least a part of the area represented by the area information may be set as a graphic block.

The processing to determine the background threshold and the processing to detect the background area may be executed by different functional units respectively.

The background area detection method is not especially limited. For example, the background area may be detected using the input image data and the processing information, just like Example 1. For the processing information, development information, a parameter value or the like may be used. The background threshold may be determined by executing the processing similar to the processing to determine the background gradation value. The background area may be detected by performing image analysis using the original image data.

The combined image represented by the combined image data is the image shown in FIG. 2A, and if the graphic image area is not considered, the result shown in FIG. 5B is acquired as a result of determining whether the block is the background block or the object block.

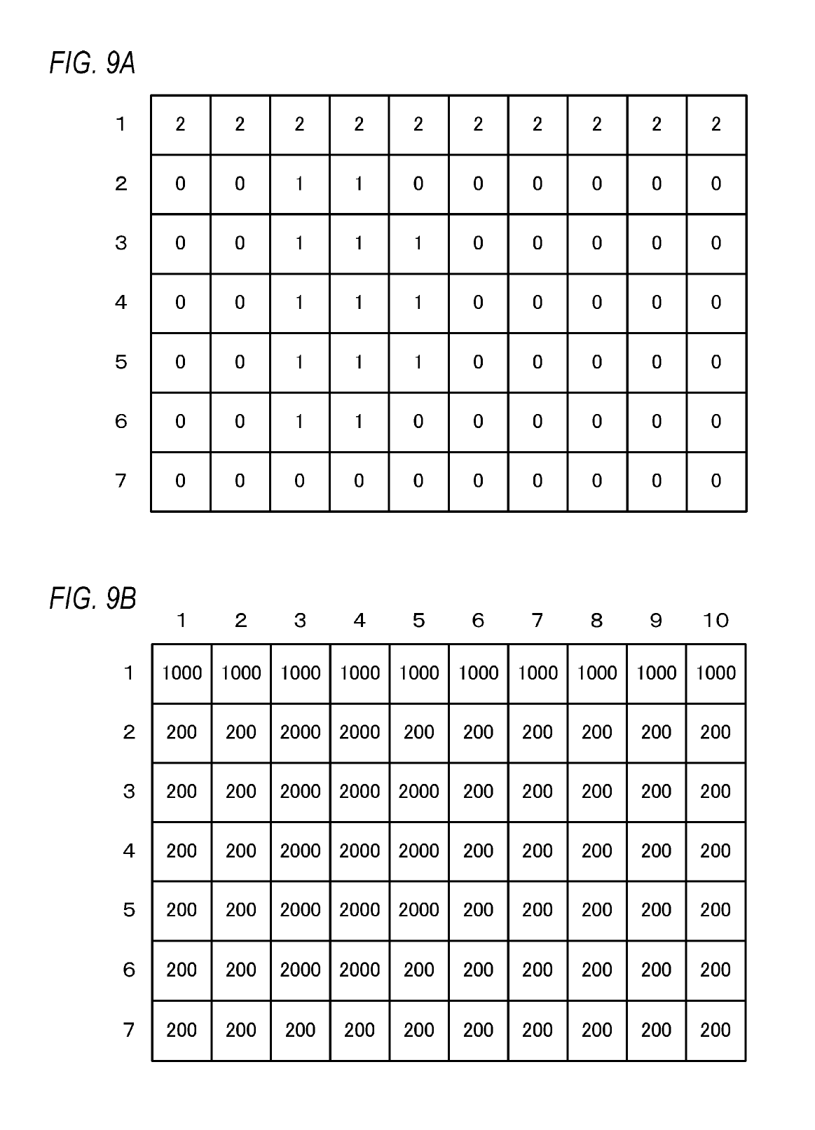

In this example, ten blocks in the positions (horizontal position, vertical position)=(1, 1) to (10, 1) are determined as graphic blocks based on the area information. Therefore in this example, the result shown in FIG. 9A is acquired as the determination result of each block. In FIG. 9A, “0” indicates the background block, “1” indicates the object block, and “2” indicates the graphic block.

The target brightness determination unit 324 acquires the background area detection result from the area determination unit 323, and acquires the first level, the second level and the third level from the control unit 321.

The target brightness determination unit 324 determines the target brightness of each light source based on the background area detection result (determination result by the area determination unit 323). In this example, the target brightness determination unit 324 sets the first level as the target brightness of the light sources disposed in the object area, and sets the second level as the target brightness of the light sources disposed in the background area. And the target brightness determination unit 324 sets the third level as the target brightness of the light sources disposed in the graphic area. In concrete terms, the target brightness determination unit 324 sets the first level as the target brightness of the light sources disposed in the object block, and sets the second level as the target brightness of the light sources disposed in the background block. And the target brightness determination unit 324 sets the third level as the target brightness of the light sources disposed in the graphic block.

The target brightness determination unit 324 outputs the target brightness information that represents the target brightness of each light source, to the output I/F 326.

It is assumed that the first level is 2000 [cd/m²], the second level is 200 [cd/m²], and the third level is 1000 [cd/m²], and the combined image is the image shown in FIG. 2A. In this case, the value shown in FIG. 9B is acquired as the target brightness of each light source based on the determination result in FIG. 9A. Since the third level is one-half of the first level, a deterioration in visibility of the graphic image and a drop in contrast due to leaked light can be suppressed.

The output I/F 326 outputs the input image data outputted from the gamma processing unit 108 and the target brightness information outputted from the target brightness determination unit 324 to the image display apparatus 300 via the image and data input/output unit 312.

As described above, according to this example, the image output apparatus that can use the original image data executes the background detection processing and the target brightness determination processing. If the background area is detected using processed image data, the processing information is also used. Thereby the background area can be very accurately detected, and a proper value can be determined as the target brightness of each light source.

In this example, the target brightness information is used as control reference information, which is the information on the background area detection result and is information used for controlling the emission brightness of each light source, but the control reference information is not limited to the target brightness information. For example, the target brightness determination processing, to determine the target brightness based on the background area detection result, may be executed by the image display apparatus. In this case, the information that represents the background area detection result is outputted to the image display apparatus as the control reference information.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-148801, filed on Jul. 22, 2014, which is hereby incorporated by reference herein in its entirety.

What is claimed is:

1. An image display apparatus that can be connected with an image output apparatus, comprising:
an emission unit that has a plurality of light sources;
a display unit configured to display an image on a screen by modulating light from the emission unit;
a first acquisition unit configured to acquire input image data from the image output apparatus;
a second acquisition unit configured to acquire processing information, which is information on image processing executed when the input image data is generated, from the image output apparatus;
a detection unit configured to detect a predetermined area in an area of an image represented by the input image data, based on gradation values of the input image data and the processing information; and
a control unit configured to control emission brightness of each light source based on the detection result of the detection unit, when an image based on the input image data is displayed on the screen.

2. The image display apparatus according to claim 1, wherein
the processing information is information that represents a gradation value of a predetermined color that can be taken by the input image data.

3. The image display apparatus according to claim 2, wherein
the processing information is information that represents gradation values of the predetermined area of the input image data.

4. The image display apparatus according to claim 1, wherein
the image processing includes at least one of offset processing in which an offset value is added to gradation values of image data, and gamma conversion processing in which the gradation values of the image data are converted by using a gamma value, and
the processing information includes at least one of the offset value of the offset processing and the gamma value of the gamma conversion processing.

5. The image display apparatus according to claim 1, wherein
when the image based on the input image data is displayed on the screen, the control unit:
controls the emission brightness of light sources disposed in an area outside the predetermined area to a first level; and
controls the emission brightness of light sources disposed in the predetermined area to a second level which is lower than the first level.

6. The image display apparatus according to claim 1, wherein
a graphic image is disposed in the image represented by the input image data,
the image display apparatus further comprises a third acquisition unit configured to acquire area information, which is information that represents an area of the graphic image in an area of the image represented by the input image data, from the image output apparatus, and
the control unit controls emission brightness of each light source based on the detection result of the detection unit and the area information, when the image based on the input image data is displayed on the screen.

7. The image display apparatus according to claim 6, wherein
when the image based on the input image data is displayed on the screen, the control unit:
controls the emission brightness of light sources disposed in an area outside the predetermined area and outside the area of the graphic image to a first level;
controls the emission brightness of light sources disposed in the predetermined area to a second level which is lower than the first level; and
controls the emission brightness of light sources disposed in the area of the graphic image to a third level which is a level between the first level and the second level.

8. The image display apparatus according to claim 7, wherein
the third level is one-half of the first level.

9. The image display apparatus according to claim 1, wherein
the predetermined area is an area of a background.

10. An image output apparatus that can be connected with an image display apparatus, comprising:
an image processing unit configured to generate input image data from original image data by executing image processing;
a first output unit configured to output the input image data to the image display apparatus; and
a second output unit configured to output processing information, which is information on the image processing, to the image display apparatus.

11. The image output apparatus according to claim 10, wherein
the image processing unit generates input image data that represents an image where a graphic image is disposed, by executing the image processing and combining processing to combine image data that represents an image where the graphic image is disposed, and
the image output apparatus further comprises a third output unit configured to output area information, which is information that represents an area of the graphic image in an area of an image represented by the input image data, to the image display apparatus.

12. The image output apparatus according to claim 10, wherein
the processing information is information that represents a gradation value of a predetermined color that can be taken by the input image data.

13. The image output apparatus according to claim 12, wherein
the processing information is information that represents gradation values of a predetermined area of an image represented by the input image data.

14. The image output apparatus according to claim 13, wherein
the predetermined area is an area of a background.

15. The image output apparatus according to claim 10, wherein
the image processing includes at least one of offset processing in which an offset value is added to gradation values of image data, and gamma conversion processing in which the gradation values of the image data are converted by using a gamma value, and
the processing information includes at least one of the offset value of the offset processing and the gamma value of the gamma conversion processing.

16. An image output apparatus that can be connected with an image display apparatus, wherein
the image display apparatus includes:
an emission unit that has a plurality of light sources; and
a display unit configured to display an image on a screen by modulating light from the emission unit, and
the image output apparatus includes:
an image processing unit configured to generate input image data from original image data by executing at least one image processing;
a detection unit configured to detect a predetermined area in an area of an image represented by the input image data, based on gradation values of processed image data, which is generated from the original image data by executing a part or all of the at least one image processing, and processing information that is information on image processing executed when the processed image data is generated;
a first output unit configured to output the input image data to the image display apparatus; and
a fourth output unit configured to output control reference information, which is information on the detection result of the detection unit and is information used for controlling emission brightness of each light source, to the image display apparatus.

17. The image output apparatus according to claim 16, further comprising a determination unit configured to determine, for each light source, target brightness that is a target value of emission brightness of the light source, based on the detection result of the detection unit, wherein
the control reference information is target brightness information that represents the target brightness of each light source determined by the determination unit.

18. The image output apparatus according to claim 17, wherein
the determination unit:
sets a first level as the target brightness of light sources disposed in an area outside the predetermined area; and
sets a second level, which is lower than the first level, as the target brightness of light sources disposed in the predetermined area.

19. The image output apparatus according to claim 17, wherein
the image processing unit generates input image data that represents an image where a graphic image is disposed, by executing the at least one image processing and combining processing to combine image data that represents an image where the graphic image is disposed, and
the determination unit determines the target brightness of each light source based on the detection result of the detection unit and area information, which is information that represents an area of the graphic image.

20. The image output apparatus according to claim 19, wherein
the determination unit:
sets a first level as the target brightness of light sources disposed in an area outside the predetermined area and outside the area of the graphic image;
sets a second level, which is lower than the first level, as the target brightness of light sources disposed in the predetermined area; and
sets a third level, which is a level between the first level and the second level, as the target brightness of light sources disposed in the area of the graphic image.

21. The image output apparatus according to claim 20, wherein
the third level is one-half of the first level.

22. The image output apparatus according to claim 16, wherein
the processing information is information that represents a gradation value of a predetermined color that can be taken by the processed image data.

23. The image output apparatus according to claim 22, wherein
the processing information is information that represents gradation values of the predetermined area of the processed image data.

24. The image output apparatus according to claim 16, wherein
the at least one image processing includes at least one of offset processing in which an offset value is added to gradation values of image data and gamma conversion processing in which the gradation values of the image data are converted by using a gamma value, and
the processing information includes at least one of the offset value of the offset processing and the gamma value of the gamma conversion processing.

25. The image output apparatus according to claim 16, wherein
the predetermined area is an area of a background.

26. A control method for an image display apparatus that can be connected with an image output apparatus,
the image display apparatus including:
an emission unit that has a plurality of light sources; and
a display unit configured to display an image on a screen by modulating light from the emission unit,
the control method for the image display apparatus comprising:
a first acquisition step of acquiring input image data from the image output apparatus;
a second acquisition step of acquiring processing information, which is information on image processing executed when the input image data is generated, from the image output apparatus;
a detection step of detecting a predetermined area in an area of an image represented by the input image data, based on gradation values of the input image data and the processing information; and
a control step of controlling emission brightness of each light source based on the detection result in the detection step, when an image based on the input image data is displayed on the screen.

27. A control method for an image output apparatus that can be connected with an image display apparatus, comprising:
an image processing step of generating input image data from original image data by executing image processing;
a first output step of outputting the input image data to the image display apparatus; and
a second output step of outputting processing information, which is information on the image processing, to the image display apparatus.

28. A control method for an image output apparatus that can be connected with an image display apparatus,
the image display apparatus including:
an emission unit that has a plurality of light sources; and
a display unit configured to display an image on a screen by modulating light from the emission unit,
the control method for the image output apparatus comprising:
an image processing step of generating input image data from original image data by executing at least one image processing;
a detection step of detecting a predetermined area in an area of an image represented by the input image data based on gradation values of processed image data, which is generated from the original image data by executing a part or all of the at least one image processing, and processing information that is information on image processing executed when the processed image data is generated;
a first output step of outputting the input image data to the image display apparatus; and
a fourth output step of outputting control reference information, which is information on the detection result in the detection step and is information used for controlling emission brightness of each light source, to the image display apparatus.
